(19) United States
(12) Patent Application Publication
(10) Pub. No.: US 2012/0303394 A1
(43) Pub. Date: Nov. 29, 2012

(54) LIMOUSINE DRIVER MANAGEMENT APPLICATION

(76) Inventor: Brook Michelle WANDERAAS, Las Vegas, NV (US)

(21) Appl. No.: 13/450,684

(22) Filed: Apr. 19, 2012

Related U.S. Application Data
(60) Provisional application No. 61/476,864, filed on Apr. 19, 2011.

(51) Int. Cl. G06Q 10/02

(52) U.S. Cl. 705/5

(57) ABSTRACT

A program adaptable to be run on a tablet computer or other mobile device, and which includes a microprocessor, random access memory, non-volatile memory, such as a hard drive or flash drive, a keyboard or other input means, a wireless communication means, such as Wi-Fi or 3g or 4g, and a display panel. The system provides a set of work tools for use by a limousine driver or concierge, including a guest greeting sign, calendar for trip planning and contact information, notepad, airport, or other real-time transport information, fleet control, passenger entertainment means, curb-side check-in, and promotional messaging.

This application claims priority under 35 U.S.C. 119(e) to U.S. Provisional Application No. 61/476,864, filed on Apr. 19, 2011, the contents of which are incorporated herein by reference.

Software applications to assist travelers to be run on portable electronic devices are well, known. One such application is disclosed in US Published Patent Application 2010/0190510, incorporated herein by reference. The application disclosed therein includes means to provide the traveler access to services provided by airlines, access to gate services, and access to in-flight services, as well as means to notify a third party of the user's arrival.

Limousine drivers and dispatchers require access to some of the same services, as well as information regarding passengers to be picked up, airport information, and information concerning delays. Moreover, the driver must prepare a sign to alert the arriving passenger of the driver's identity.

A programmable sign for an airport greeter is known from US Published Patent Application 2008/0079600.

The invention is therefore directed to a software application, typically for a tablet computer, for consolidating and streamlining many of the jobs performed by a limousine driver.

In particular, a driver will receive an assignment to pick up a passenger at an airport, which will include the tasks of scheduling the pickup at a particular time at a particular terminal, determining the scheduled landing time, and preparing a sign to alert the passenger.

If the limousine is part of a fleet, the dispatcher may want to schedule the pickup just before arrival, based on the driver being closest to the airport.

If the limousine is being sent by a hotel, particularly to pick up a VIP, the hotel may desire to facilitate the comfort and convenience of the passenger.

To facilitate the above objects, the invention is directed to an application to be run on a portable electronic device, particularly a tablet computer, but which may also be run on a laptop or even a smart phone, depending on which of the multiple functions are being used. The device should include a microprocessor, random access memory, non-volatile memory such as a hard drive or flash drive, an input device such as a real or virtual keyboard, a wireless communications means, such as wifi and/or 3G, and a display.

### DESCRIPTION OF THE DRAWINGS

FIG. 1 is a screen shot showing the information available on the calendar screen;

FIG. 2 is a screen shot showing messages pushed to the drivers electronically;

FIGS. 3 and 4 are screen shots depicting how drivers can access a keyboard to type information which can be sent by e-mail or saved;

FIGS. 5 and 6 are screen shots showing information concerning arrival times and locations;

FIG. 7 is a screen shot showing a pick-up sign;

FIGS. 8 through 10 show several examples of signs that can be created;

FIG. 11 is a screen shot of an editing screen;

FIG. 12 is a screen shot of the tablet configured for adult passenger entertainment;

FIG. 13 is a screen shot of the tablet configured for a child's passenger entertainment;

FIG. 14 is a master flow chart for all functions of the app;

FIG. 15 is the calendar flow chart;

FIG. 16 is the fleet control flow chart;

FIG. 17 is the flow chart for entering notes;

FIG. 18 is the airport flow chart;

FIG. 19 is a remote check-in flow chart; and

FIG. 20 is the signage creation flow chart.

The management app includes a “workbench function” for the driver, including a calendar app for entering the name and flight schedule for the passenger, an area for entering notes relating to the passenger, a signage app for creating a sign on the computer display large enough to be read by the arriving passenger and including a selectable font and background, and a check-in app, which connects to the hotel computer system, and allows the driver or the passenger to check in before arriving at the hotel.

Where the driver is part of a fleet, the management app connects to an app at the fleet headquarters or on a server accessible from fleet headquarters, to permit transfer of scheduling information to the driver.

The app also includes a guest entertainment system for the passenger, which will allow the passenger to access e-mail and the internet, and obtain information about the hotel. The guest information screen can contain advertising, and can be selected to provide information to children or to adults.

The driver's workbench function is divided into six parts:

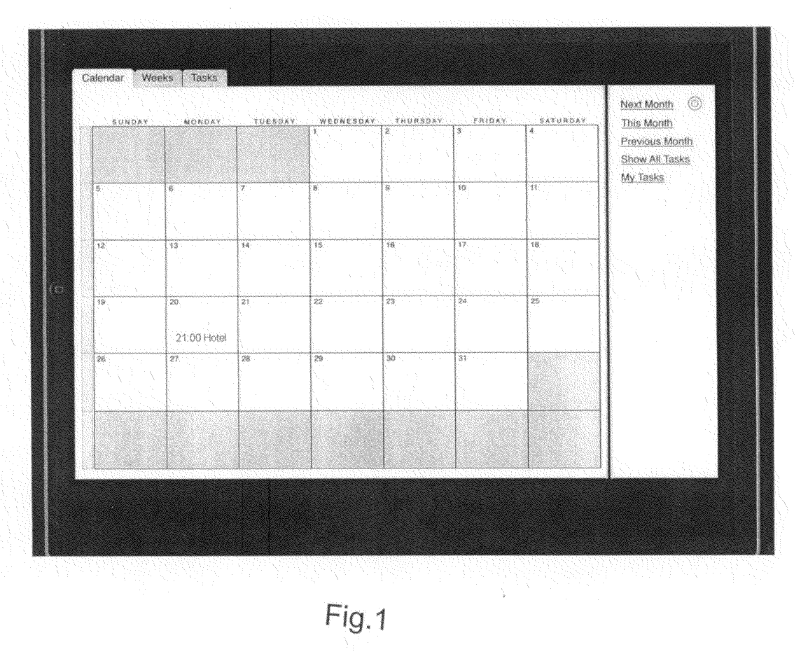

Calendar function, where the driver can book, keep control and alter his existing agreements. In a company installation, the calendars are shared among all or a group of fleet drivers. The Calendar offers functionality to transfer pickups between the cars in the fleet, and to register details about picking up the customer. A central clerk can have access to all the fleets calendars and keep control over the phone calls and agreements with customer. See FIG. 1 in this regard.

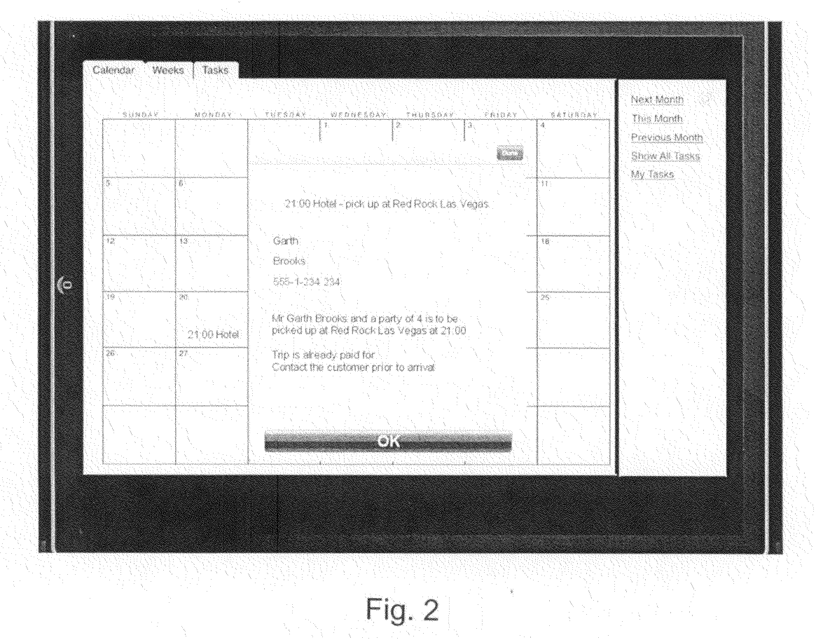

Fleet Control, which is the central database and communication server between a fleet of cars. The central clerk can at all times see where his fleet is located via GPS, and can using this information to route the closest vehicle to the pickup. A short messaging system as on FIG. 2 can also push information to the drivers.

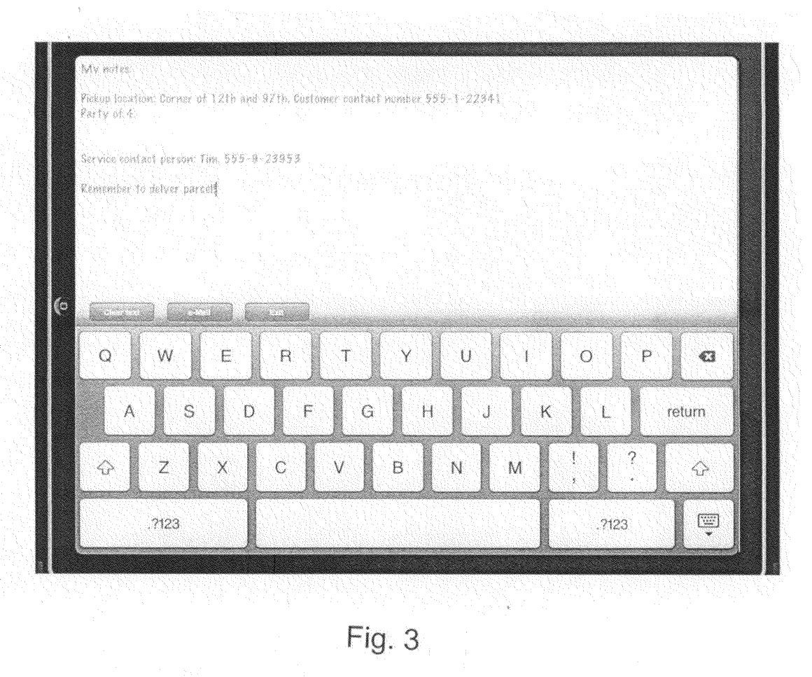

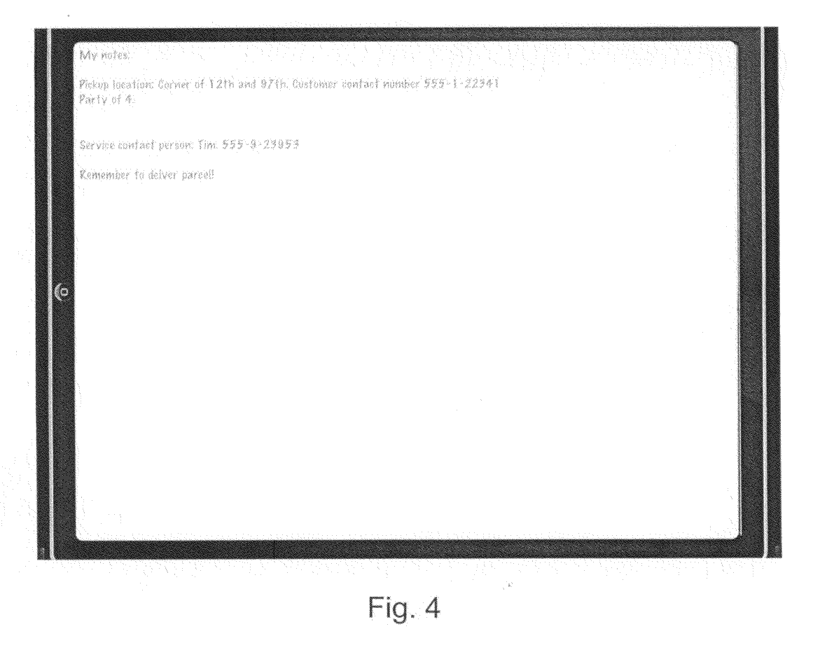

Notes, where the driver can type details, phone numbers and agreements quickly during the day are text based, and can be sent by email, or saved into the fleet database where applicable as seen in FIGS. 3 and 4.

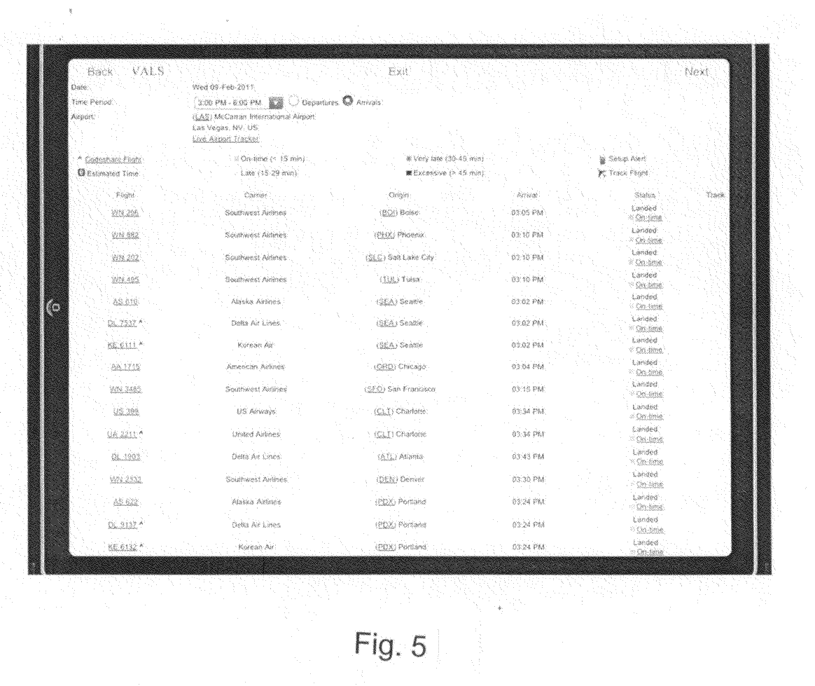

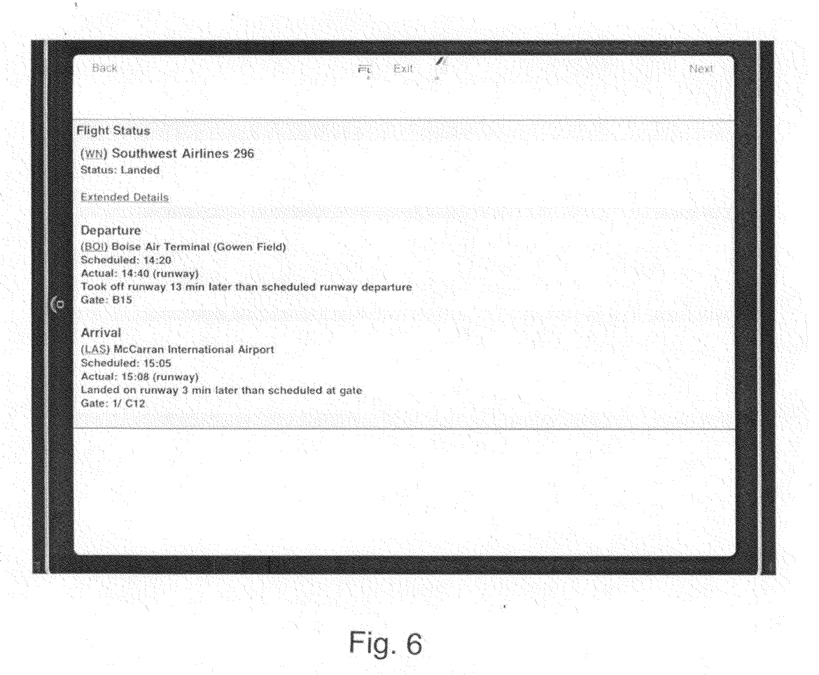

Airport Info, where the driver can get detailed information of arrival times and locations from the local airport, port or train station are depicted in FIGS. 5 and 6.

Curb Side Check in, where the driver can check the customer into the hotel prior to arrival. Typically, this involves a direct wireless connection to the hotel computer system.

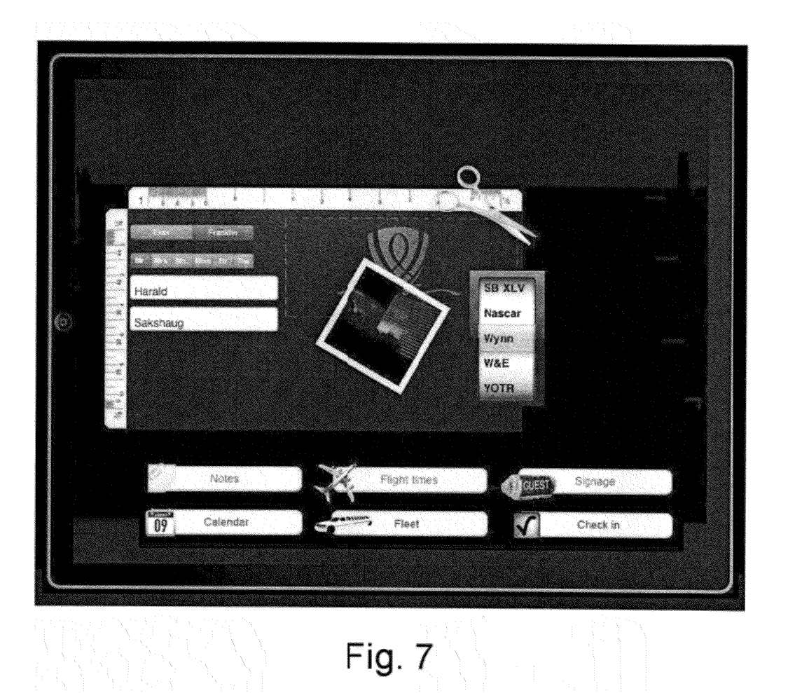

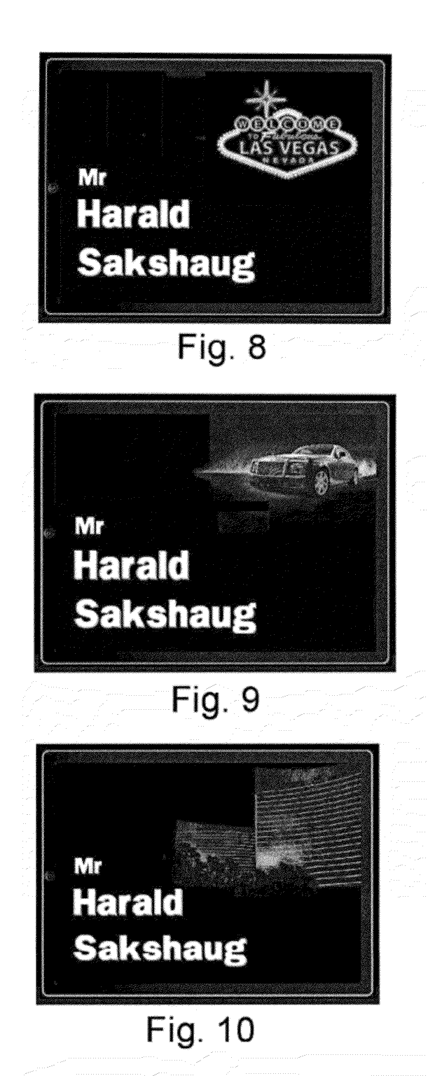

Signage Creation is shown in FIG. 7, where the user can 10 onsite literally in seconds create beautiful and market oriented pickup signage. Using the signage editor the driver can create signage which has the name of the guest visible from a distance, along with marketing information about the destination or other graphics which has relevance to the guest. Typically, the sign display will be in at least 36 point type, visible from about 5 feet, to about 168 point type, visible from a much greater distance. Signage examples are shown in FIGS. 8-10.

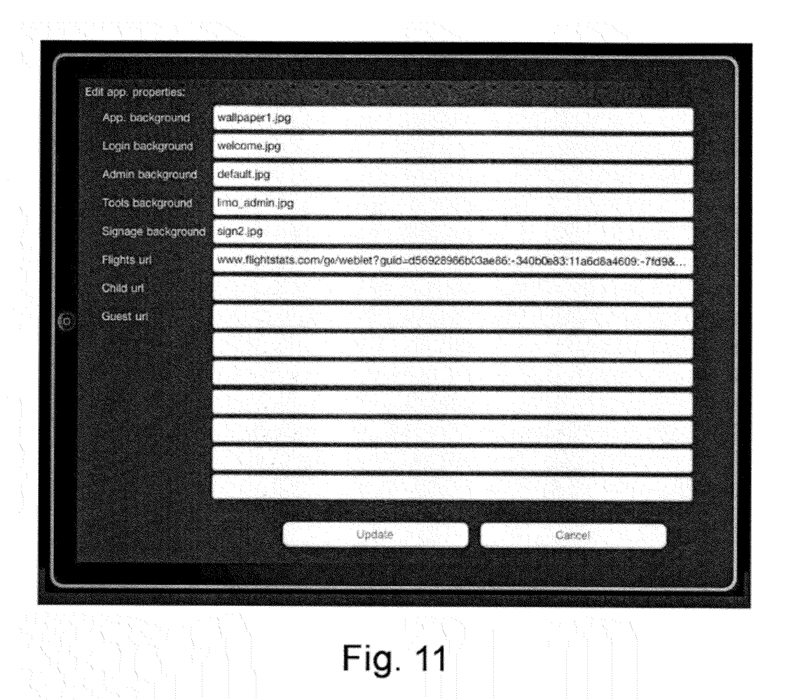

Quite a few of the options of the Signage Creation can be tweaked to be most suitable to the passenger and customer, using a screen shown in FIG. 11.

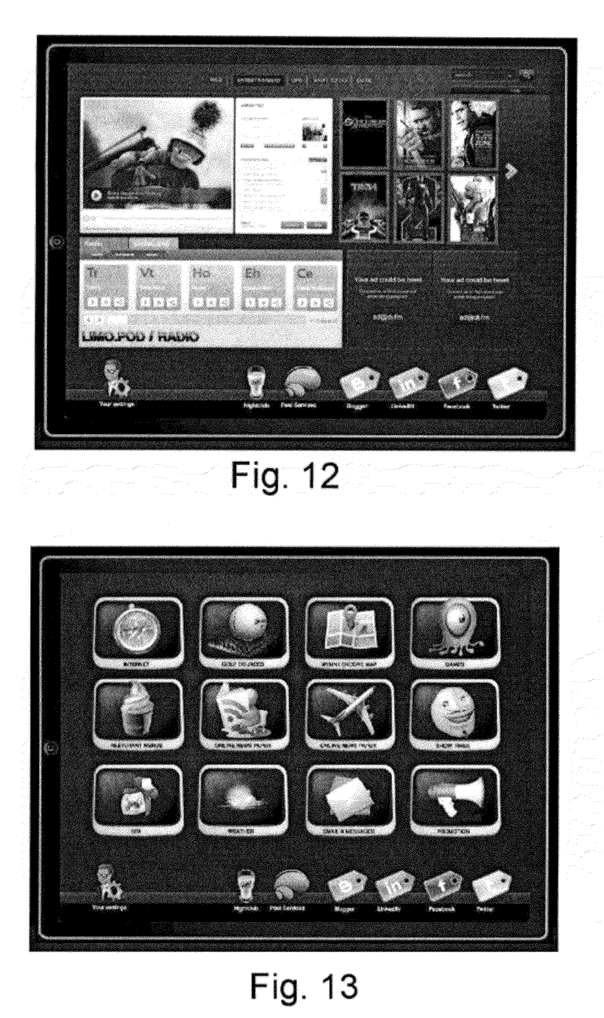

The driver has the ability to pass the computer to the passenger to entertain the passenger during the ride. In that case, a “guest” account is selected at login, and the computer will display a passenger's screen which is selectable for adults (FIG. 12) or for children (FIG. 13).

The app, of course, requires the driver to enter a login name and password to verify his identity, and displays further screens based on existing legal requirements.

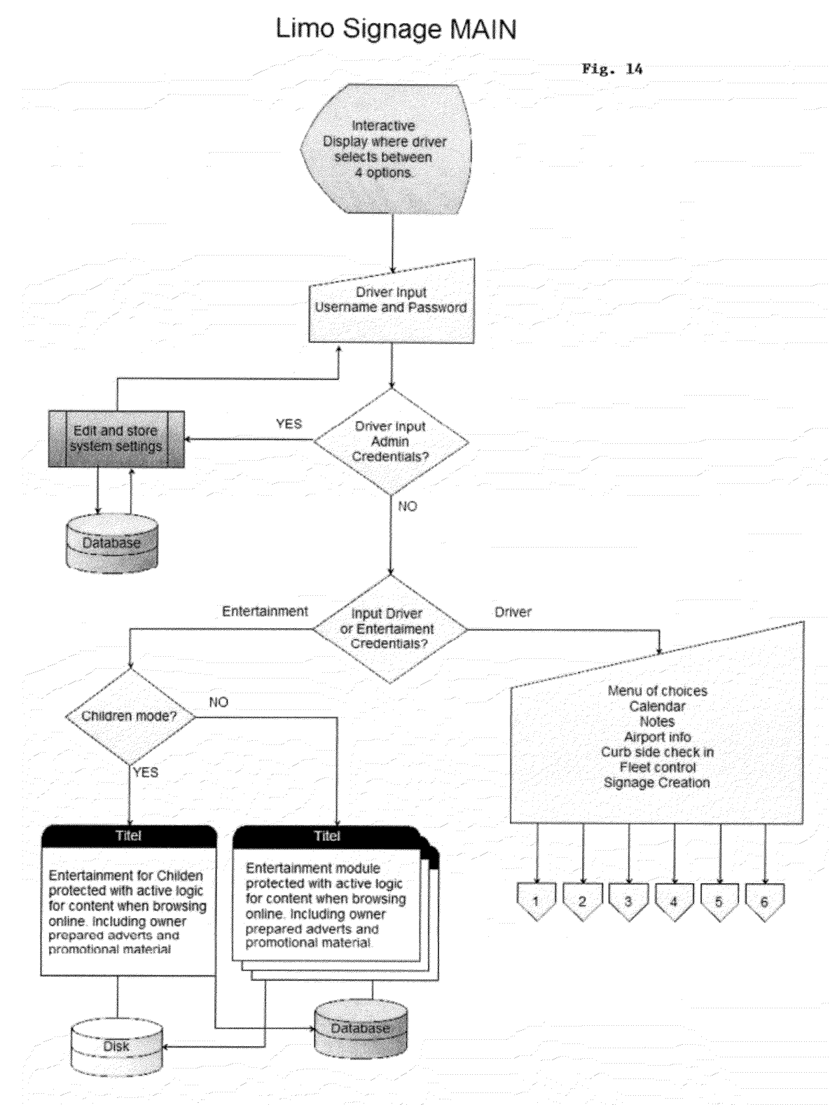

FIGS. 14-20 are flowcharts for the functions of the app described above.

FIG. 14 shows the master flowchart for all functions of the app.

Thus, if the driver logs in with admin credentials, the driver will have access to system settings. Without admin credentials, the driver will either have access to the driver menu or to the entertainment menu for the passengers.

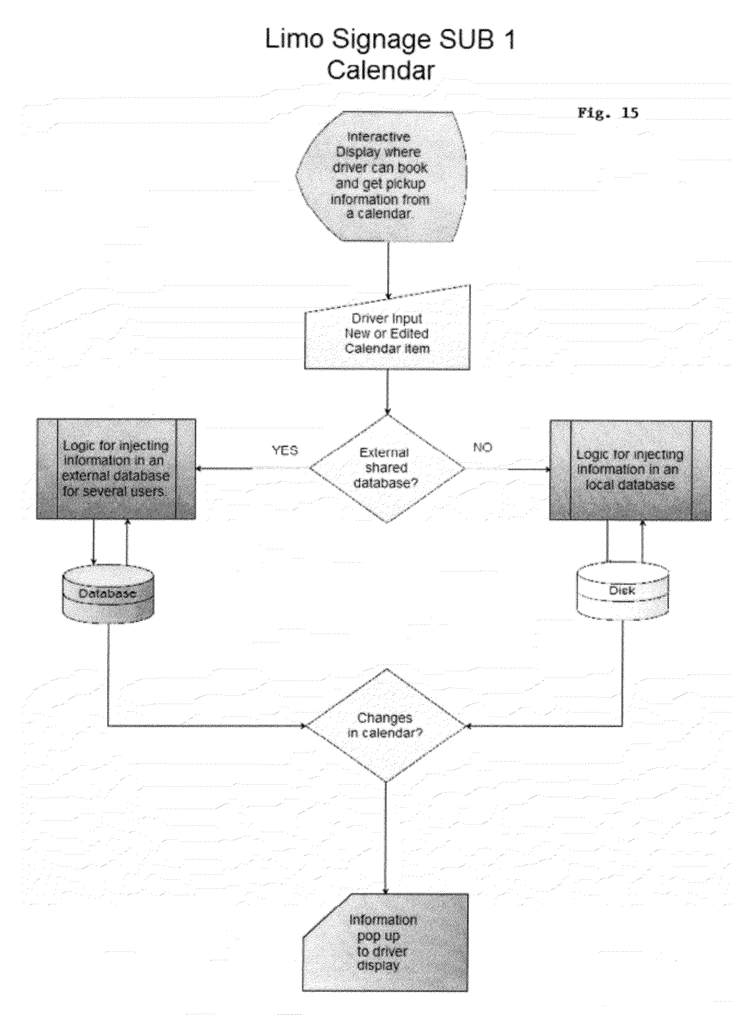

In FIG. 15 the calendar flowchart, gives the driver access either to an external database for several users, or to the local database.

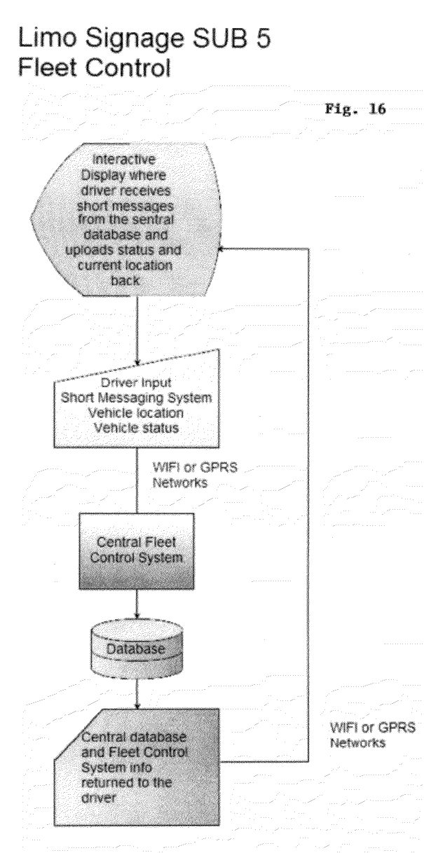

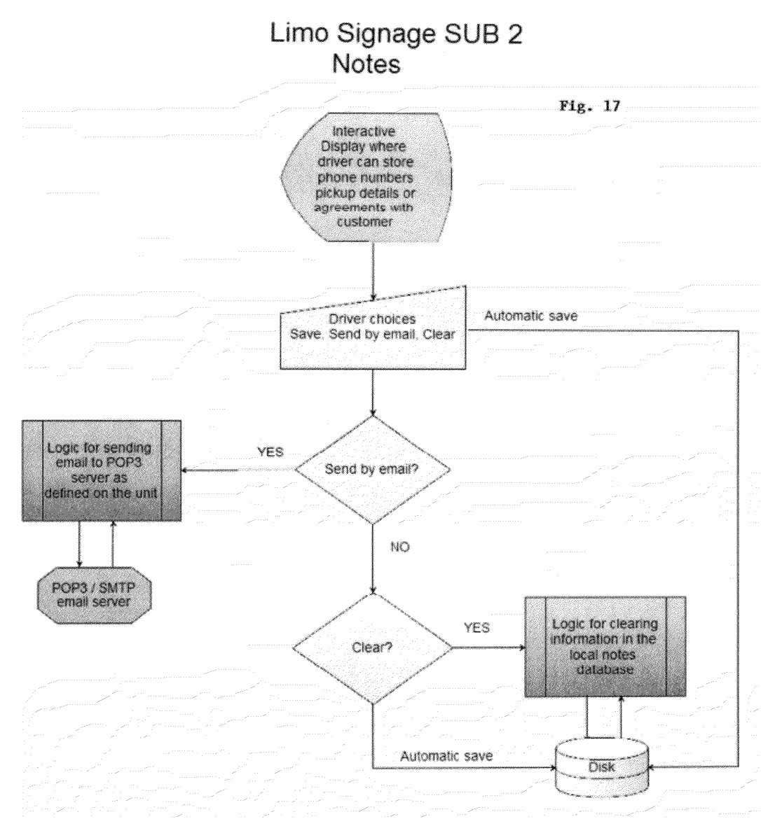

FIG. 16 is the fleet control flowchart, giving the fleet manager the ability to send a message to the driver, obtain location and status information, and update the calendar.

The notes flowchart in FIG. 17, gives 20 the driver the ability to enter short notes, and the ability to send the notes by e-mail

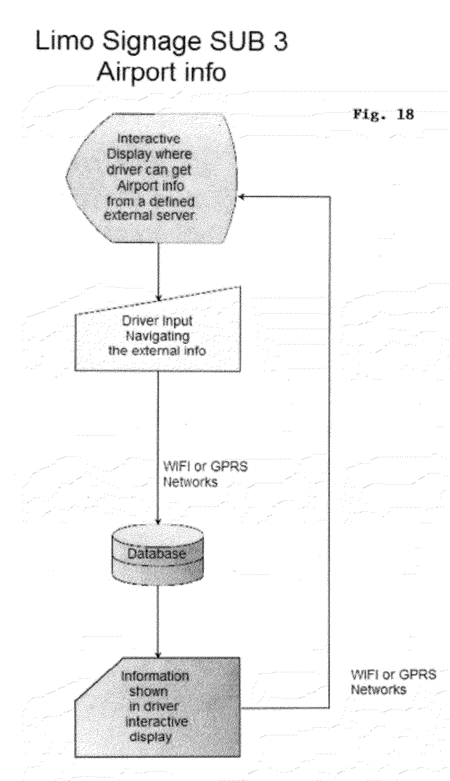

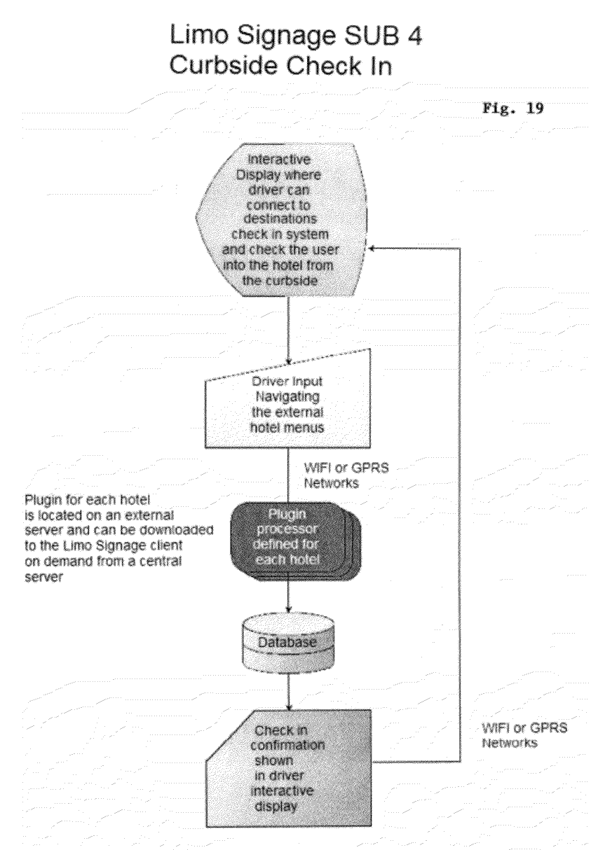

FIG. 18 is the airport info flowchart, giving the driver wireless access to airport and flight information, external to the app,

FIG. 19 is the remote check-in flowchart, giving the driver access to remote hotel menus, and providing a confirmation of the check in information.

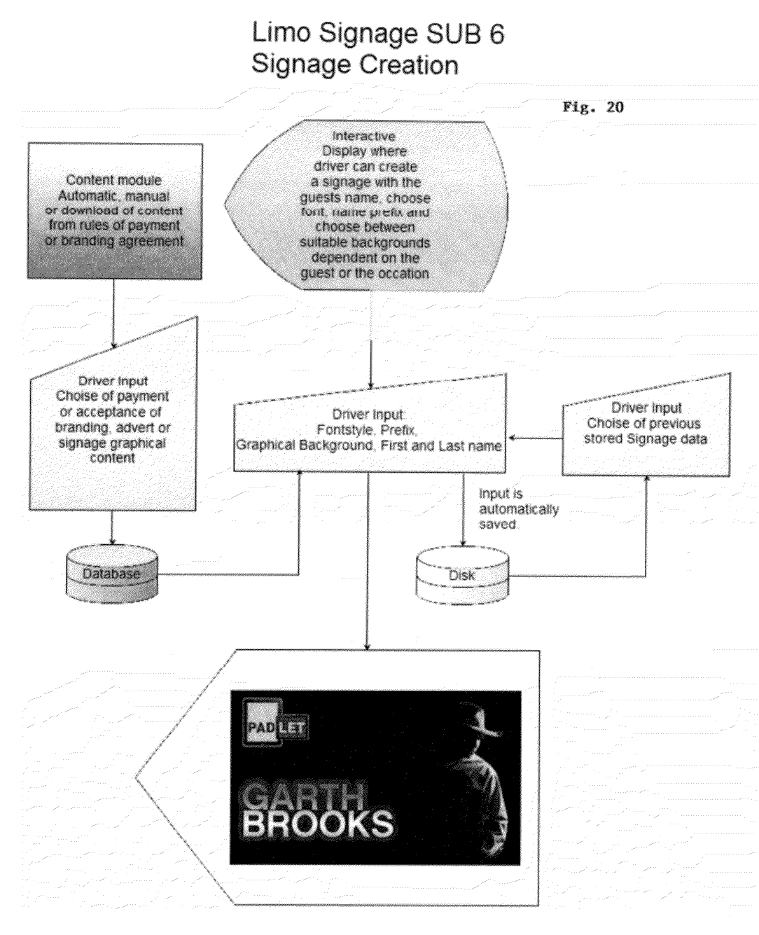

FIG. 20 is a flowchart for the signage creation function, giving the driver access to a variety of backgrounds, and enabling the driver to enter passenger information automatically or manually in a choice of fonts.

What is claimed is:

1. Limousine driver management software application to be run on a computer with a display and an input device, comprising:
means for entering a name of a passenger and other information relating to the passenger to be picked up in a calendar;
means for creating a sign with a selectable background which is visible to the passenger at a distance of at least 10 feet;
means for recording notes regarding the passenger pick up in the calendar;
means for providing wireless access to information regarding passenger arrival time through a selected transportation mode;
means for wirelessly accessing a reservation system at a hotel to enable the driver to remotely check the passenger into the hotel;
means for providing entertainment and information to the passenger utilizing the computer; and
means for wirelessly providing access to the calendar and the notes to a remote user, to thereby remotely provide information to the driver.

2. The software application of claim 1, wherein the computer with a display is a tablet computer.

3. The software application as set forth in claim 1, wherein the input device is a virtual keyboard.

4. The software application as set forth in claim 1, wherein means are provided for a remote central office to push information via wireless means to said display.

5. The software application as set forth in claim 1, wherein recorded notes and like informational messages can be transmitted from said computer by electronic mail.
